(19) United States
(12) Patent Application Publication
(10) Pub. No.: US 2010/0333018 A1
(43) Pub. Date: Dec. 30, 2010

(54) INFORMATION PROCESSING APPARATUS AND NON-TRANSITORY COMPUTER READABLE MEDIUM

(76) Inventor: Shunichi Numazaki, Hachioji-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/823,662

(22) Filed: Jun. 25, 2010

(30) Foreign Application Priority Data
Jun. 30, 2009 (JP) 2009-156337

(51) Int. Cl. G06F 3/048; G06F 3/041; G06F 3/02

(52) U.S. Cl. 715/800; 345/173; 345/168

(57) ABSTRACT

According to one embodiment, an information processing apparatus includes a display device, a touch panel located on a screen of the display device, a sensing module which senses that a particular touch operation is performed on the touch panel, an enlarged display module which enlarges a partial image in a display image determined based on a position where the particular touch operation is performed when the sensing module detects the particular touch operation, and a touch operation control module which accepts a touch operation by correcting a position of the touch operation on the partial image enlarged by the enlarged display module to a position on the display image and which cancels enlarged display performed by the enlarged display module, when the touch operation is performed in an area on the touch panel corresponding to a display area of the partial image enlarged by the enlarged display module.

### CROSS-REFERENCE TO RELATED APPLICATIONS

This application is based upon and claims the benefit of priority from Japanese Patent Application No. 2009-156337, filed Jun. 30, 2009; the entire contents of which are incorporated herein by reference.

### FIELD

Embodiments described herein relate generally to a user interface technique suitable for an information processing apparatus known as a tablet PC (Personal computer), for example, and formed to enable touch operations to be performed on a display screen.

### BACKGROUND

In recent years, various types of PCs, such as a desk-top type and a notebook type have been widely utilized. PCs of this kind generally accept user's instructions input by operating a keyboard, a mouse, and the like. However, PCs have recently started to prevail which include a touch panel allowing user's instructions to be accepted via touch operations (using a finger or a pen) on the display screen. PCs enabling touch operations on the display screen are called, for example, tablet PCs.

With the prevalence of tablet PCs, various mechanisms for allowing comfortable touch operations on the display screen have been proposed (see, for example, Jpn. Pat. Appln. KOKAI Publication No. 2008-146135).

A display control apparatus described in Jpn. Pat. Appln. KOKAI Publication No. 2008-146135 provides a function for enlarging a specified portion of a display image. Furthermore, multiwindow displays are now in common use, and much effort has been made to increase the resolution of such display devices. Thus, for example, operation buttons are displayed in reduced form. As a result, when a touch operation is performed in an area in which a plurality of operation buttons are closely arranged, unintended operations buttons are often depressed. The use of the enlarged display function allows touch operations to be performed with such an area enlarged. This allows usability to be improved.

However, in the display control apparatus described in Jpn. Pat. Appln. KOKAI Publication No. 2008-146135, an area enlarged in response to a touch operation is fixedly specified. Thus, even if a user who does not intend to enlarge the image performs a touch operation, enlarged display is performed. This may even more severely degrade the usability for some users.

Furthermore, after a touch operation is performed on the enlarged image, a certain separate operation is expected to be required in order to cancel the enlarged display. Thus, also in this regard, there is room for improvement in usability.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is an exemplary diagram showing the appearance of an information processing apparatus according to an embodiment.

FIG. 2 is an exemplary diagram showing the system configuration of the information processing apparatus according to the embodiment.

FIG. 3 is an exemplary first conceptual drawing illustrating an outline of user support provided by a touch operation support utility operating on the information processing apparatus according to the environment.

FIG. 4 is an exemplary second conceptual drawing illustrating an outline of the user support provided by the touch operation support utility operating on the information processing apparatus according to the environment.

FIG. 5 is an exemplary functional block diagram illustrating the operational principle of the user support provided by the touch operation support utility operating on the information processing apparatus according to the environment.

FIG. 6 is an exemplary flowchart showing the operation of the user support based on the touch operation support utility operating on the information processing apparatus according to the environment.

### DETAILED DESCRIPTION

Various embodiments will be described hereinafter with reference to the accompanying drawings.

In general, according to one embodiment, an information processing apparatus includes a display device, a touch panel located on a screen of the display device, a sensing module which senses that a particular touch operation is performed on the touch panel, an enlarged display module which enlarges a partial image in a display image determined based on a position where the particular touch operation is performed when the sensing module detects the particular touch operation, and a touch operation control module which accepts a touch operation by correcting a position of the touch operation on the partial image enlarged by the enlarged display module to a position on the display image and which cancels enlarged display performed by the enlarged display module, when the touch operation is performed in an area on the touch panel corresponding to a display area of the partial image enlarged by the enlarged display module.

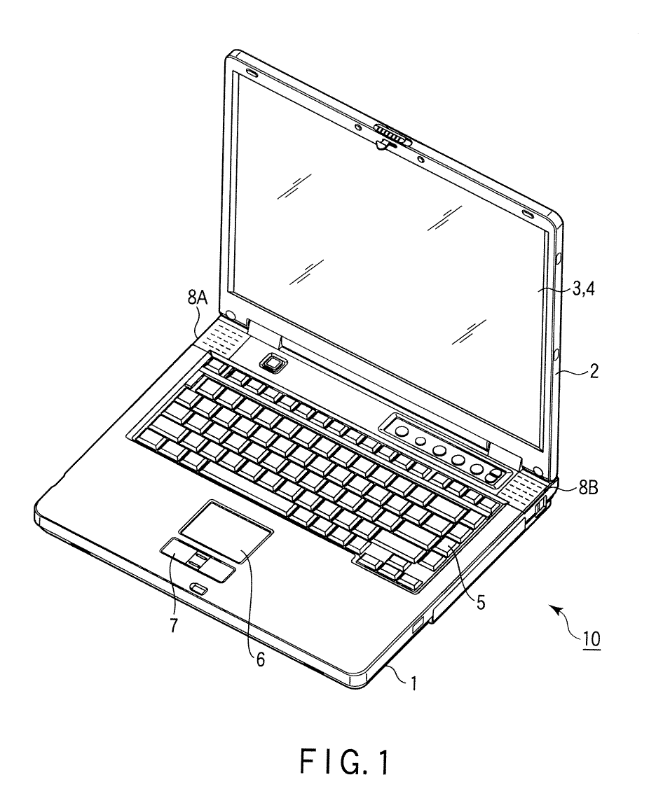

FIG. 1 is an exemplary diagram showing the appearance of an information processing apparatus according to the present embodiment. The information processing apparatus is implemented as a notebook type tablet PC (computer 10).

As shown in FIG. 1, the present computer 10 includes a main body 1 and a display unit 2. The display unit 2 incorporates an LCD (Liquid crystal display) 3 and a touch panel 4 so that the LCD 3 is superimposed on the touch panel 4. The display unit 2 is attached to the main body 1 so as to be pivotally movable between an open position where the top surface of the main body 1 is exposed and a closed position where the top surface of the main body 1 is covered.

On the other hand, the main body 1 to which the display unit 2 is pivotally movably attached includes a thin box-shaped housing, and a keyboard 5, a touch pad 6, a mouse button 7, and speakers 8A and 8B arranged on the top surface of the main body 1.

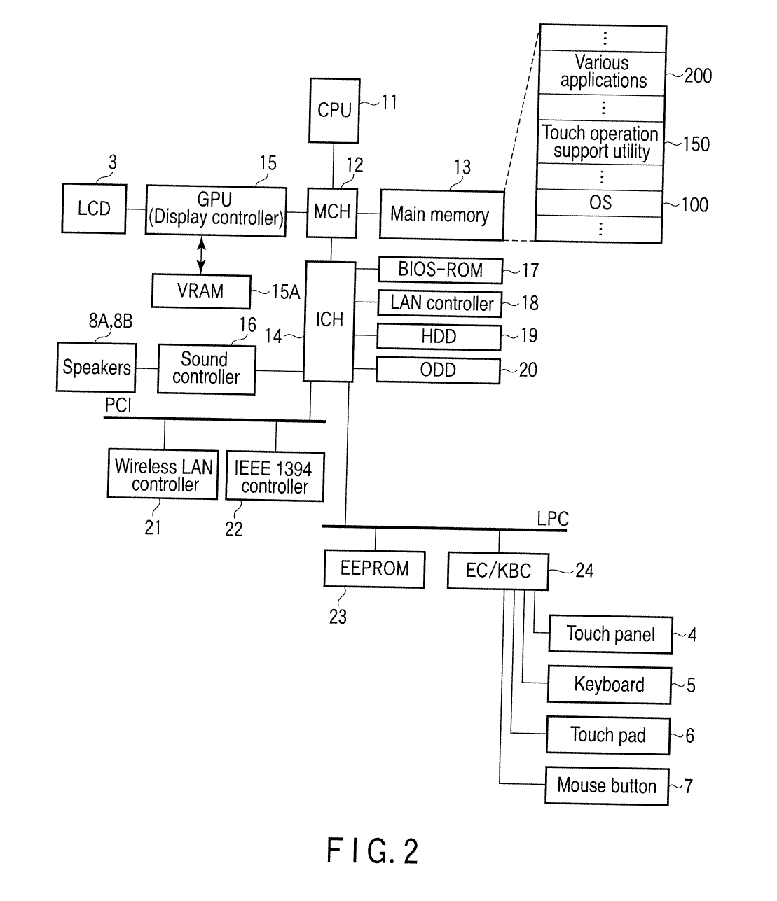

FIG. 2 is an exemplary diagram showing the system configuration of the computer 10. As shown in FIG. 2, the computer 10 includes CPU (Central processing unit) 11, MCH (Memory controller hub) 12, a main memory 13, ICH (I/o controller hub) 14, GPU (Graphics processing unit; display controller) 15, a video memory (VRAM) 15A, a sound controller 16, BIOS (Basic input/output system)-ROM (Read only memory) 17, a LAN (Local area network) controller 18, HDD (Hard disk drive) 19, ODD (Optical disc drive) 20, a wireless LAN controller 21, an IEEE 1394 controller 22, EEPROM (Electrically erasable programmable ROM) 23, and EC/KBC (Embedded controller/keyboard controller) 24.

CPU 11 is a processor formed to control the operation of the computer 10 to execute various programs loaded from HDD 19 or ODD 20 into the main memory 13. The various programs executed by CPU 11 include OS 100 for resource management and various application programs 200 formed to operate under the control of OS 100. Furthermore, in the computer 10, a touch operation support utility 150 described below operates as a resident program under the control of OS 100 (similarly to the application programs 200). CPU 11 also executes BIOS stored in BIOS-ROM 17. The BIOS is a program for hardware control.

MCH 12 operates as a bridge formed to connect CPU 11 and ICH 14 together and as a memory controller formed to control accesses to the main memory 13. Furthermore, MCH 12 includes a function to communicate with GPU 15.

GPU 15 is a display controller formed to control LCD 3 incorporated in the display unit 2. GPU 15 includes a VRAM 15A, which is a video memory, and an accelerator formed to draw images to be displayed by various programs, instead of CPU 11.

ICH 14 controls devices on a PCI (Peripheral component interconnect) bus and devices on an LPC (Low pin count) bus. ICH 14 includes a built-in IDE (Integrated device electronic) controller formed to control HDD 19 and ODD 20. ICH 14 also includes a function for communication with the sound controller 16 and the LAN controller 18.

The sound controller 16 is a sound source device formed to output audio data to be reproduced by various programs, to speakers or the like.

The LAN controller 18 is a wired communication device formed to perform wired communication in conformity with, for example, the IEEE 802.3 standard. On the other hand, the wireless LAN controller 21 is a wireless communication device formed to perform wireless communication in conformity with, for example, the IEEE 802.11 standards. Furthermore, the IEEE 1394 controller 22 communicates with external apparatuses via a serial bus conforming to the IEEE 1394 standard.

EEPROM 23 is a memory device formed to store, for example, identification information on the computer 10.

EC/KBC 24 is a one-chip MPU (Micro processing unit) in which an embedded controller and a keyboard controller are integrated; the embedded controller manages power, and the keyboard controller controls data input performed by operating the touch panel 4, the keyboard 5, the touch pad 6, or the mouse button 7.

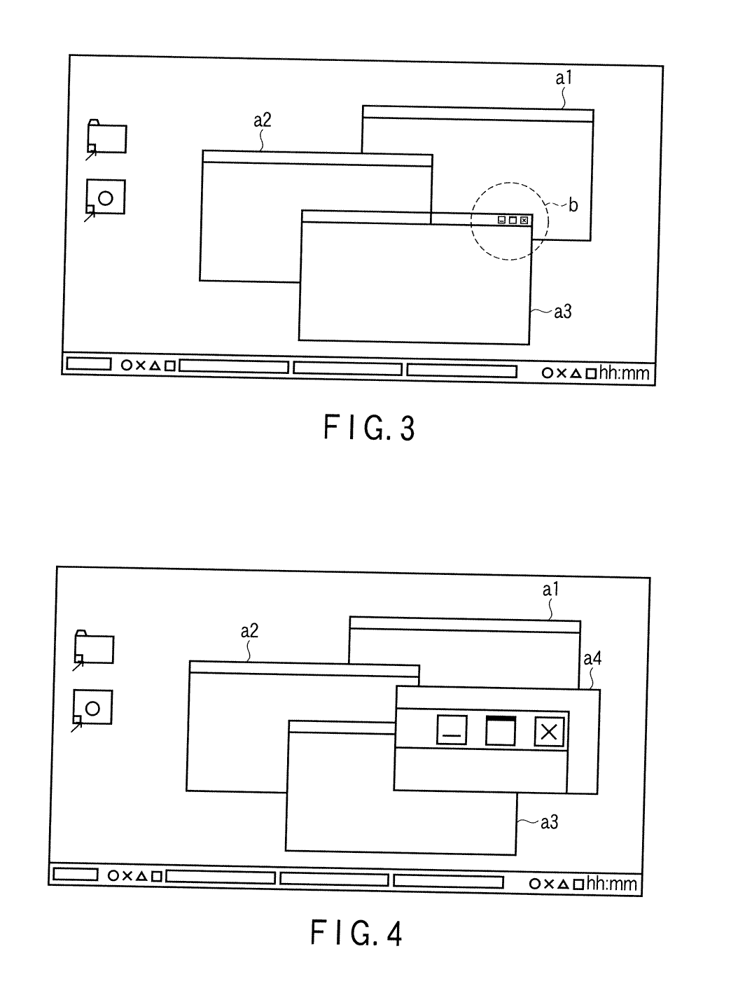

Now, user support by a touch operation support utility 150 operating on the computer 10 formed as described above will be described in brief with reference to FIG. 3 and FIG. 4.

As shown in FIG. 1 and FIG. 2, the computer 10 can accept data input performed by the user, via the touch panel 4, the keyboard 5, the touch pad 6, and the mouse button 7. The touch operation support utility 150 is a program allowing the user to comfortably operate the touch panel 4.

It is assumed that three windows, “a1”, “a2” and “a3”, are displayed on LCD 3 (on which the touch panel 4 is superimposed) as shown in FIG. 3 (multiwindow display). Thus, an operation button group arranged at the upper right end (area “b”) of the window “a3” is displayed in a reduced form.

In this situation, the following is assumed: a user (user A) attempts to touch one of the operation buttons in the area “b” of the window “a3” utilizing a pen, and another user (user B) attempts to perform a touch operation with a fingertip.

In this case, the user A's touch operation allows a position to be pinpointed, whereas the user B's touch operation is likely to be erroneous. More specifically, the computer is likely to determine that instead of the intended operation button, the adjacent operation button has been depressed. Furthermore, when some pens are located close to the screen, a cursor may be displayed on the screen (before the pen touches the screen), for a structural reason. If such a pen is utilized, accurate touches can be easily achieved.

In contrast, a finger does not allow the cursor to be displayed on the screen before coming into contact with the screen. Thus, accurate touches are difficult. Therefore, provided that the area “b” of the window “a3” can be temporarily enlarged for touch operations, such erroneous operations as described above can be conveniently prevented.

On the other hand, it is more efficient for the user A to directly operate within the area “b” of the window “a3”. Thus, first, the touch operation support utility 150 provides a function to enlarge a peripheral area around the position which corresponds to a base point and at which a particular touch operation, for example, a 2-finger tap, which is a form of multi-touch, is performed. FIG. 4 shows that the touch operation support utility 150 has displayed an enlarged window “a4” because a particular touch operation has been performed in the area “b” of the window “a3” shown in FIG. 3.

The particular touch operation may be, for example, a form of operation in which two fingers are simultaneously brought into contact with the touch panel 4 or a form of operation in which with one finger in contact at a specified position, for example, the lower left end of the display screen, another finger is brought into contact with the surface of the display screen. In this case, the position touched by the second finger is used as a position to be enlarged. Alternatively, a combination of a particular key (on the keyboard 5) and a touch or a combination of any other hard button and a touch is applicable.

If the operation in the area of the window “a3” is not the particular touch operation, the operation is not determined to be an instruction for enlarged display but to be a normal touch operation on the window “a3”. Thus, the user A can perform a direct operation. That is, in response to an intended particular touch operation for instruction for enlarged display, the touch operation support utility 150 enlarges the peripheral area around the position.

Furthermore, the touch operation on the enlarged display window “a4” shown in FIG. 4 temporarily replaces the touch operation on the window “a3”. Thus, secondly, the touch operation support utility 150 provides a function to automatically cancel the display of the enlarged display window “a4” if this alternative touch operation is performed.

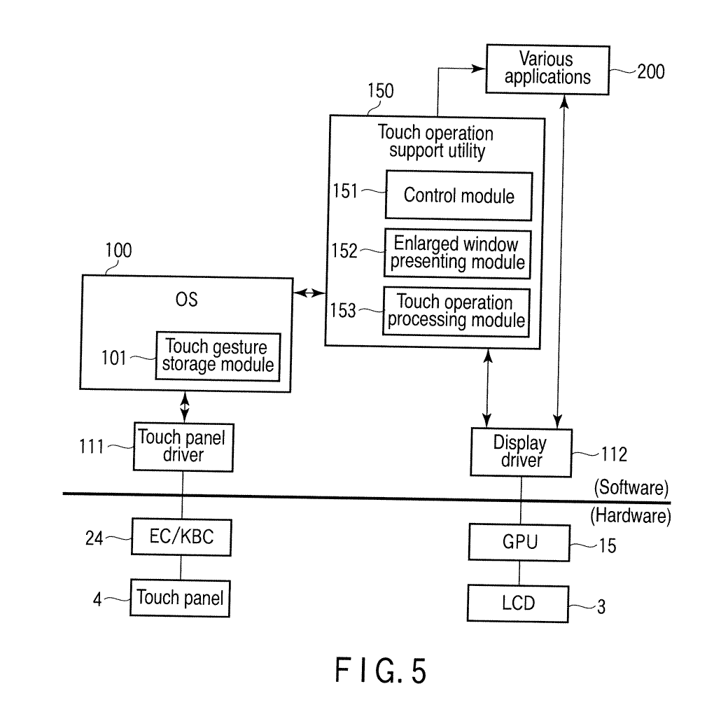

FIG. 5 is an exemplary functional block diagram illustrating the operational principle of user support provided by the touch operation support utility 150.

As described above, the data input performed by operating the touch panel 4 is controlled by EC/KBC 24. The image display by LCD 3 is controlled by GPU 15. A touch panel driver 111 and a display driver 112 operating on the computer 10 serve as programs allowing EC/KBC 24 and GPU 15 (both of which are hardware) to be controlled by software.

The various application programs 200 display screens including operation buttons and the like, on LCD 3 via the display driver 112 (through GPU 15). When the user uses any of the various application programs 200 to perform a touch operation on the screen displayed on LCD 3, that is, on the touch panel 4, OS 100 is notified of the operation via the touch panel driver 111 (through EC/KBC 24).

OS 100 includes a touch gesture storage module 101. In connection with the touch operation on the touch panel 4 of which OS 100 has been notified by the touch panel driver 111, OS 100 can determine that any of various touch operations have been performed, including not only a single touch in which the user points at the target position with one finger or pen but also various forms of multi-touches, for example, a 2-finger tap in which the user touches the touch panel 4 simultaneously with two fingers or pens (gesture determination). If a single touch has been performed, OS 100 transmits an event notification indicating that the single touch has been performed as well as the position of the single touch, to the program displaying the window at the position where the touch operation has been performed.

The touch operation support utility 150 intercepts (hooks) an event notification (relating to a touch operation) transmitted to any of the application programs 200 by OS 100. When started in synchronism with the start-up of the computer 10, the touch operation support utility 150, which is a resident program, requests, in initial processing, OS 100 to transmit an event notification to the touch operation support utility 150. If the hooked event notification indicates that the particular touch operation has been performed, the touch operation support utility 150 enlarges the peripheral area around the position indicated in the event notification and which corresponds to the base point.

To perform the above-described operation, the touch operation support utility 150 includes a control module 151, an enlarged window presenting module 152, and a touch operation processing module 153.

The control module 151 not only performs a procedure required to hook an event notification as described above but also provides a user interface for various other settings. More specifically, the control module 151 allows the user to select the type of the particular touch operation for instruction for enlarged display. The control module 151 presents gestures, which are determinable by the OS 100, as choices based on the touch gesture storage module 101 so that the user can select one of the gestures as the particular touch operation for instruction for enlarged display. The control module 151 also allows the user to optionally adjust an enlargement rate for the enlarged display.

The enlarged window presenting module 152 is a module formed to generate an enlarged image of the peripheral area around the position at which the particular touch operation has been performed and which corresponds to the base point, and to display the enlarged image on LCD 3 via the display driver 112 (through GPU 15). If the hooked event notification indicates that the particular touch operation has been performed, the control module 151 notifies to the enlarged window presenting module 152 of the position indicated in the event notification. If the hooked event notification indicates that a touch operation different from the particular one has been performed, the control module 151 relays the event notification to the relevant one of the application programs 200 which originally receives the event notification.

Upon being notified of the position information by the control module 151, the enlarged window presenting module 152 requests OS 100 to provide the enlarged display window “a4” (at the position indicated in the event notification). The enlarged window presenting module 152 acquires, via the display driver 112, image data of the peripheral area corresponding to the indicated position; the image data is stored in VRAM 15A by GPU 15. The enlarged window presenting module 152 then generates and transfers a corresponding enlarged image to the display driver 112 so as to allow the enlarged image to be displayed on the provided enlarged display window “a4”.

After the enlarged display window “a4” is presented by the enlarged window presenting module 152, the control module 151 having hooked the event notification determines, based on the position information in the event notification, whether or not the touch operation has been performed within the enlarged display window “a4”. If the touch operation has been performed within the enlarged display window “a4”, the control module 151 transfers the event notification to the touch operation processing module 153. On the other hand, if the touch operation has not been performed within the enlarged display window “a4”, the control module 151 relays the event notification to the relevant one of the application programs 200 which originally receives the event notification.

The touch operation processing module 153 calculates a position in the peripheral area (enlarged display target) corresponding to the position at which the particular touch operation has been performed; the calculated position corresponds to the position (in the enlarged display window “a4”) indicated in the event notification transferred by the control module 151. Then, the touch operation processing module 153 corrects the event notification in accordance with the calculated position. The touch operation processing module 153 then relays the corrected event notification to the application program 200 displaying the window at the position where the particular touch operation has been performed. Once the relay is completed, the touch operation processing module 153 requests OS 100 to release the enlarged window “a4” provided by the enlarged window presenting module 152.

As described above, the touch operation support utility 150 provides a function to enlarge the target partial image for the user desiring enlarged display and to automatically cancel the enlarged display when a touch operation is performed on the enlarged partial image.

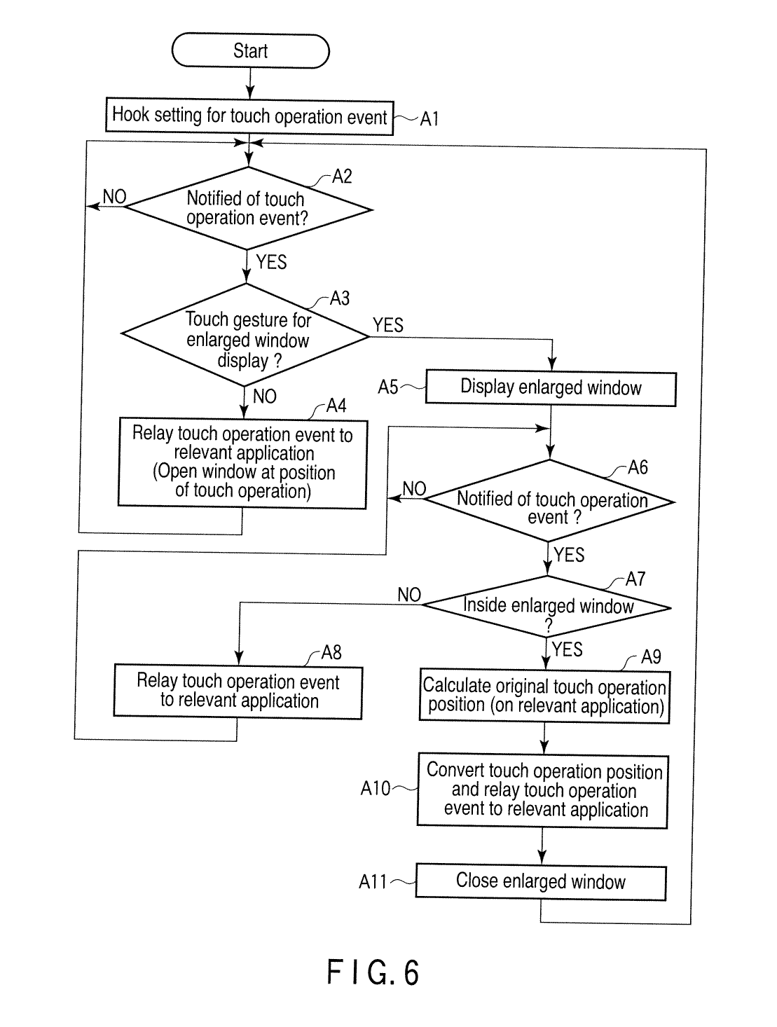

FIG. 6 is an exemplary flowchart showing the operation of the user support provided by the touch operation support utility 150.

First, the touch operation support utility 150 requests OS 100 to transmit an event notification relating to a touch operation on the touch panel 4, to the touch operation support utility 150 (block A1).

Thereafter, the touch operation support utility 150 waits for an event notification relating to a touch operation on the touch panel 4 (block A2). Upon receiving an event notification from OS 100 (YES in block A2), the touch operation support utility 150 first determines whether or not the touch operation is a particular one for instruction for enlarged display (block A3). If the touch operation is not the particular one (NO in block A3), the touch operation support utility 150 relays the event notification to the program displaying a window at the touch operation position and which originally receives the event notification (block A4).

On the other hand, if the touch operation is the particular one (YES in block A3), the touch operation support utility 150 enlarges the peripheral area corresponding to the touch operation position (block A5). Moreover, the touch operation support utility 150 waits for an event notification relating to the touch operation on the touch panel 4 (block A6).

Upon receiving the event notification from OS 100 (YES in block A6), the touch operation support utility 150 determines whether or not the touch operation position is on the enlarged display area (block A7). If the touch operation position is not on the enlarged display area (NO in block A7), the touch operation support utility 150 relays the event notification to the program displaying the window at the touch operation position and which originally receives the event notification (block A8). The touch operation support utility 150 subsequently waits for an event notification relating to the touch operation on the touch panel 4.

On the other hand, if the touch operation position is on the enlarged display area (YES in step S7), the touch operation support utility 150 calculates a position in the enlarged display target area corresponding to the touch operation position on the enlarged display area, that is, the position on the original display area (block A9). Then, the touch operation support utility 150 corrects the event notification transmitted by OS 100 in accordance with the calculated position. The touch operation support utility 150 then relays the corrected event notification to the program which originally receives the event notification (block A10). Once the relay of the corrected event notification is completed, the touch operation support utility 150 requests OS 100 to cancel the enlarged display (block All).

As described above, the computer 10 improves the convenience of touch operations performed on the touch panel 4.

The control module 151 of the touch operation support utility 150 provides a user interface configured to allow the user to make various settings. It is also effective to allow the user to set an application program formed to disable the function for the enlarged display associated with the particular touch operation.

This is to enable cases where, for example, game software in which a particular touch operation (which corresponds to an instruction for enlarged display) has a special meaning. The above-described setting allows enlarged display unintended by the user to be prevented from being performed if the particular touch operation is performed on the display screen of the application program.

Furthermore, in the above description, by way of example, the user optionally adjusts an enlargement rate for enlarged display using the user interface provided by the control module 151 of the touch operation support utility 150. However, the enlarged window presenting module 152 of the touch operation support utility 150 may automatically adjust the enlargement rate in a timely manner.

More specifically, the enlarged window presenting module 152 acquires the size of the operation button located in the enlarged display target area by the relevant application program, from OS 100. Based on the size, the enlarged window presenting module 152 determines the enlargement rate such that the operation button has a predetermined size, and then enlarges the corresponding image. Thus, the enlarged image of the operation button can always be adjusted to the appropriate size.

Furthermore, upon acquiring the position in the enlarged display target area where the operation button is located by the relevant application program, from OS 100, and then calculating the position in the enlarged display target area corresponding to the touch operation position on the enlarged display area, the touch operation processing module 153 of the touch operation support utility 150 may operate as follows. The touch operation processing module 153 carries out relay of the corrected event notification and cancellation of the enlarged display only if the calculated position corresponds to the position where the operation button is located. That is, even when a touch operation is performed on the enlarged display area, the touch operation processing module 153 maintains the enlarged display unless the operation is valid for the operation button.

The following configuration is also effective: after the enlarged window presenting module 152 and touch operation processing module 153 of the touch operation support utility 150 cooperatively perform the enlarged display, the user can optionally move and enlarge the enlarged display target area.

More specifically, if for example, a touch operation (sliding operation) is performed such that the user draws a line on the enlarged display area with two fingers, the touch operation processing module 153 determines the vector between the start point and end point of the line. The touch operation processing module 153 then corrects the vector to the corresponding one in the enlarged display target area, and notifies the enlarged window presenting module 152 of the corrected vector.

Upon being notified of the corrected vector, the enlarged window presenting module 152 generates an enlarged image of a peripheral area corresponding to a position obtained by moving the position of which the enlarged window presenting module 152 has previously been notified by the control module 151, by a distance corresponding to the vector of which the enlarged window presenting module 152 has been notified by the touch operation processing module 153. The enlarged window presenting module 152 updates the enlarged image being displayed to the generated enlarged image.

Furthermore, for example, if for example, a touch operation is performed such that two fingers are opened in the enlarged display area, the enlarged window presenting module 152 enlarges the enlarged display area or increases the enlargement rate of the enlarged image in the enlarged display area.

Furthermore, in the above description, by way of example, the touch operation support utility 150 hooks the event notification from OS 100. However, the present invention is not limited to this configuration. For example, the touch operation support utility 150 may acquire the contents (including positional information) of operation of the touch panel 4 directly from EC/KBC 24 via the touch panel driver 111.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a display device;
a touch panel located on a screen of the display device;
a sensing module configured to sense that a particular touch operation is performed on the touch panel;
an enlarged display module configured to enlarge a partial image in a display image determined based on a position where the particular touch operation is performed when the sensing module detects the particular touch operation; and
a touch operation control module configured to accept a touch operation by correcting a position of the touch operation on the partial image enlarged by the enlarged display module to a position on the display image and to cancel enlarged display performed by the enlarged display module, when the touch operation is performed in an area on the touch panel corresponding to a display area of the partial image enlarged by the enlarged display module.

2. The apparatus of claim 1, further comprising a user interface module configured to register programs for invalidating the enlarged display of the partial image performed by the enlarged display module when the sensing module senses the particular touch operation, the programs being configured to accept the particular touch operation.

3. The apparatus of claim 2, wherein the user interface module is configured to set the type of touch operation to be sensed by the sensing module provided that the particular touch operation is performed.

4. The apparatus of claim 2, wherein the user interface module is configured to set an enlargement rate for enlarged display of the partial image performed by the enlarged display module.

5. The apparatus of claim 1, wherein the particular touch operation comprises a touch operation performed with a plurality of fingers.

6. The apparatus of claim 1, wherein the particular touch operation comprises a touch operation with another touch operation performed at a preset position on the touch panel.

7. The apparatus of claim 1, further comprising a keyboard,
wherein the particular touch operation comprises a touch operation with a depression operation of a predetermined key on the keyboard.

8. The apparatus of claim 1, further comprising a hard button,
wherein the particular touch operation comprises a touch operation with a depression operation of the hard button.

9. The apparatus of claim 1, wherein the touch operation control module is configured to move an area in the display image corresponding to a target for enlarged display of the partial image performed by the enlarged display module to a sliding direction of a sliding operation, when the sliding operation is performed such that a straight line is drawn, with two fingers, in an area on the touch panel corresponding to the display area of the partial image enlarged by the enlarged display module.

10. The apparatus of claim 1, wherein the touch operation control module is configured to enlarge the display area of the partial image enlarged by the enlarged display module or to increase the enlargement rate of the partial image displayed in the display area, when a sliding operation is performed such that two fingers are open in an area on the touch panel corresponding to the display area of the partial image enlarged by the enlarged display module.

11. The apparatus of claim 1, wherein the enlarged display module is configured to determine the enlargement rate of the partial image based on the size of an operational object located on the partial image to be enlarged.

12. The apparatus of claim 1, wherein the touch operation control module is configured to accept a touch operation and to cancel enlarged display when the touch operation is performed on the operational object located on the partial image to be enlarged.

13. A non-transitory computer readable medium having stored thereon a computer program which is executable by a computer comprising a display device and a touch panel located on a screen of the display device to execute a method of touch operation support, the computer program controls the computer to execute function of:
sensing that a particular touch operation is performed on the touch panel;
enlarging a partial image in a display image determined based on a position where the particular touch operation is performed when the particular touch operation is sensed; and
accepting a touch operation by correcting a position of the touch operation on the enlarged partial image to a position on the display image and cancelling the enlarged display of the partial image when the touch operation is performed in an area on the touch panel corresponding to the display area of the enlarged partial image.
